(19) United States
(12) Patent Application Publication
(10) Pub. No.: US 2015/0117043 A1
(43) Pub. Date: Apr. 30, 2015

(54) VEHICULAR LAMP UNIT

(71) Applicant: KOITO MANUFACTURING CO., LTD., Tokyo (JP)

(72) Inventors: Hiroki SHIBATA, Shizuoka-shi (JP); Kazutami OISHI, Shizuoka-shi (JP)

(21) Appl. No.: 14/515,785

(22) Filed: Oct. 16, 2014

(30) Foreign Application Priority Data
Oct. 29, 2013 (JP) 2013-224641

(51) Int. Cl. F21S 8/10

(52) U.S. Cl. CPC F21S 48/125; F21S 48/328
USPC 362/512

(57) ABSTRACT

Disclosed is a lamp unit including a plurality of light sources and a mechanism configured to adjust a reference position of an axis according to the light sources. A projection lens unit includes a first projection lens and a second projection lens. At least some of light emitted from a first light source passes through the first projection lens. At least some of light emitted from the second light source passes through the second projection lens. A first adjusting mechanism moves the first projection lens unit in parallel in left and right directions with respect to the first light source and the second light source. A second adjusting mechanism moves the projection lens unit in upward and downward directions which are orthogonal to the left and right directions, with respect to the first light source and the second light source. At least one of a first optical axis of the first projection lens and a second optical axis of the second projection lens extends in forward and backward directions which are orthogonal to the left and right directions and the upward and downward directions.

### CROSS-REFERENCE TO RELATED APPLICATIONS

This application is based on and claims priority from Japanese Patent Application No. 2013-224641 filed on Oct. 29, 2013 with the Japan Patent Office and the disclosure of which is incorporated herein in its entirety by reference.

### TECHNICAL FIELD

The present disclosure relates to a lamp unit equipped in a vehicle.

### BACKGROUND

When a lamp unit which includes a projection lens is attached to a housing that defines a lamp chamber, an error may occur to a desired specification with respect to a reference position of an optical axis of the projection lens. A lamp unit provided with an aiming mechanism to solve such error is known.

The aiming mechanism is provided with two screws exposed to the outside of the housing. A reference position of an optical axis pertaining to upward and downward directions of the lamp unit may be adjusted by rotating one screw. A reference position of an optical axis pertaining to left and right directions of the lamp unit may be adjusted by rotating another screw (see, e.g., Japanese Patent Laid-Open Publication No. 2012-164428).

### SUMMARY

There are needs to equip a plurality of light sources in a single lamp unit. The lights emitted from the plurality of light sources pass through different projection lenses or different areas in a single projection lens, respectively, to form a predetermined light distribution pattern. In such case, a configuration in which the plurality of projection lenses are arranged in a predetermined direction or a configuration in which the projection lens extends in a predetermined direction to form a plurality of light passing areas becomes necessary and thus, structural enlargement in the predetermined direction is unavoidable.

When providing the aiming mechanism, it is necessary to secure a space in which the projection lens can be displaced according to an adjustment of the reference positions of the optical axes. When a structure surrounding the projection lens(es) is enlarged as described above, the space to be secured is also enlarged. Thus, an occupation space of the lamp unit is increased.

An object of the present disclosure is to provide a technology of reducing an occupation space of a single lamp unit which is provided with a plurality of light sources and a mechanism of adjusting reference positions of optical axes according to the light sources.

In order to achieve the object, an aspect of the present disclosure provides a lamp unit equipped in a vehicle. The lamp unit includes: a first light source; a second light source; a projection lens unit which includes a first lens unit through which at least some of light emitted from the first light source passes and a second lens unit through which at least some of light emitted from the second light source passes; a first adjusting mechanism configured to move the projection lens unit in parallel in a first direction with respect to the first light source and the second light source; and a second adjusting mechanism configured to move the projection lens unit in parallel in a second direction with respect to the first light source and the second light source. The second direction is orthogonal to the first direction. At least one of a first optical axis of the first lens unit and a second optical axis of the second lens unit extends in a third direction which is orthogonal to the first and the second directions.

According to such a configuration, when positions of the plurality of optical axes included in the projection lens unit are performed in unison, the projection lens unit does not involve a displacement of the lamp unit in the third direction. Since it is not necessary to secure a space for the displacement in the third direction, an occupation space where the lamp unit is disposed may be suppressed in a lamp chamber of a lighting device and the space inside the lamp chamber may be effectively utilized. In a case where a projection lens unit which has a plurality of optical axes and tends to be enlarged in structure is displaced, the above-mentioned effect becomes more remarkable.

In addition, since the projection lens unit is moved in parallel, a relative position between a focal plane of the first lens unit and the first light source and a relative position between a focal plane of the second lens unit and the second light source are not changed when the reference positions of the first optical axis and the second optical axis are adjusted. Therefore, imaging of the light emitted from the first light source and the light from the second light source (i.e., formation of a light distribution pattern) may be stabilized.

The first adjusting mechanism includes a first shaft member having a first axis extending in the first direction, and a first bearing member configured to hold the first shaft member and the second adjusting mechanism includes a second shaft member having a second axis extending in the second direction, and a second bearing member configured to hold the second axis member. The first axis and the second axis may be configured to intersect each other between the first lens unit and the second lens unit when viewed in the third direction.

According to such a configuration, a displacement axis in the left and right directions and a displacement axis in the upward and downward directions may intersect each other at a position adjacent to a center of gravity of the projection lens unit. Therefore, the projection lens unit which have a plurality of optical axes and tends to be increased in size and weight may be stably displaced.

The lamp unit may be provided with an actuator including a driving shaft coupled to the second axis member, and the second direction may correspond with the upward and downward directions of the vehicle.

According to such a configuration, a control of moving the reference positions of the first optical axis and the second axis in the upward and downward directions of the vehicle according to a variation of the height of the vehicle which is caused depending on the number of passenger and load on the vehicle. That is, the mechanism that moves the projection lens in parallel in the second direction may also be used for a so-called leveling control.

The first lens unit may include a first projection lens and the second lens unit may include a second projection lens which is independent of the first projection lens.

According to such a configuration, standardization of a lens component may be facilitated, and a component cost and a manufacturing cost may be suppressed.

The above-described summary is for the illustration purpose only and does not intend to limit in any ways. In addition to the illustrative embodiments, examples, and features described above, further embodiments, examples, and features will become apparent by referring to the drawings and the following detailed descriptions.

### BRIEF DESCRIPTION OF THE DRAWINGS

FIG. 1 is a right side view illustrating a lighting device including a lamp unit according to an exemplary embodiment of the present disclosure, in a partial sectional view.

FIG. 2 is an exploded perspective view of the lamp unit of FIG. 1 which is viewed from a front and upper side.

FIG. 3 is a perspective view of the lamp unit of FIG. 1 which is viewed from a front and lower side.

FIG. 4 is a perspective view of a portion of the lamp unit illustrated in FIG. 1 which is viewed from a rear and upper side.

FIGS. 5A to 5C are plan views for describing an operation of moving a projection lens unit provided in the lamp unit of FIG. 1 in parallel in left and right directions.

FIG. 6 is an exploded perspective view illustrating a second adjusting mechanism provided in the lamp unit of FIG. 1.

FIGS. 7A to 7C are front views for describing an operation of moving the projection lens unit provided in the lamp unit in parallel in upward and downward directions.

FIGS. 8A and 8B are front views for describing actions of an actuator illustrated in FIG. 6.

FIG. 9 is a front view illustrating a modified embodiment of the projection lens unit.

### DETAILED DESCRIPTION

In the following detailed descriptions, reference is made to the accompanying drawings which form a part of the present disclosure. The illustrative embodiments described in the detailed descriptions, drawings, and claims do not intend to limit. Other embodiments may be utilized and other modified examples may be made without departing from the spirit or scope of the subject matter presented in the disclosure.

Hereinafter, exemplary embodiments of the present disclosure will be described in detail with reference to accompanying drawings. In each drawing referred to in the following description, scales are properly changed in order to illustrate each member in a recognizable size. Further, “right side” and “left side” used in the following description represent right and left directions when viewed from a driver seat.

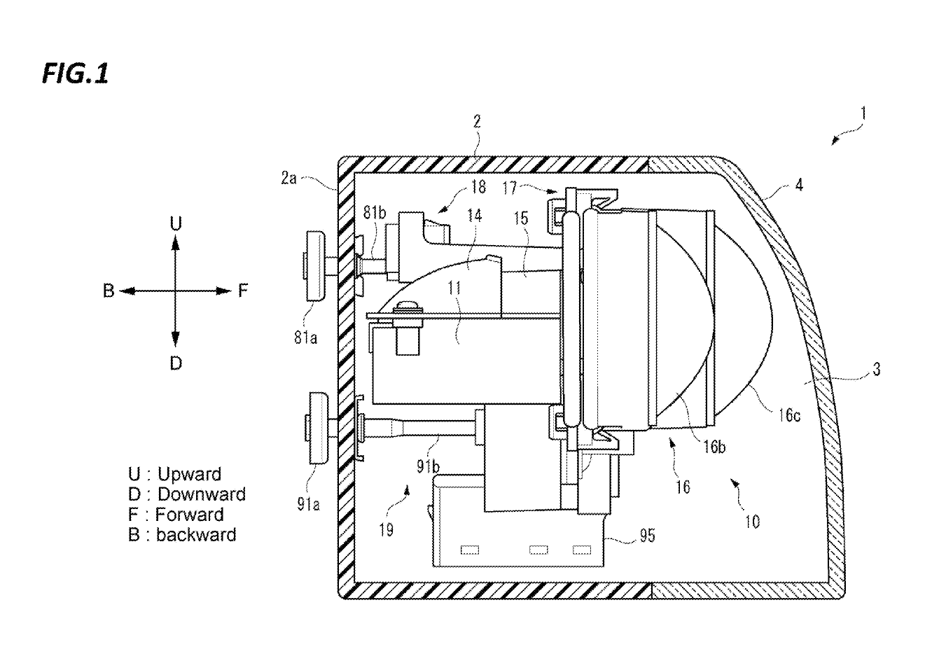

FIG. 1 is a view illustrating a headlight device 1 which is viewed from the right side after a portion of the headlight device is sectioned vertically. The headlight device 1 is equipped in a front portion of a vehicle to illuminate the front side of the vehicle. The headlight device 1 is provided with a housing 2 and a light-transmissive cover 4 mounted on the housing 2 to define a lamp chamber 3. A lamp unit 10 according to an exemplary embodiment is disposed in the lamp chamber 3.

The lamp unit 10 is provided with a heat sink 11, a first light source unit 12, a second light source unit 13, a first reflector 14, a second reflector 15, a projection lens unit 16, and a joint unit 17.

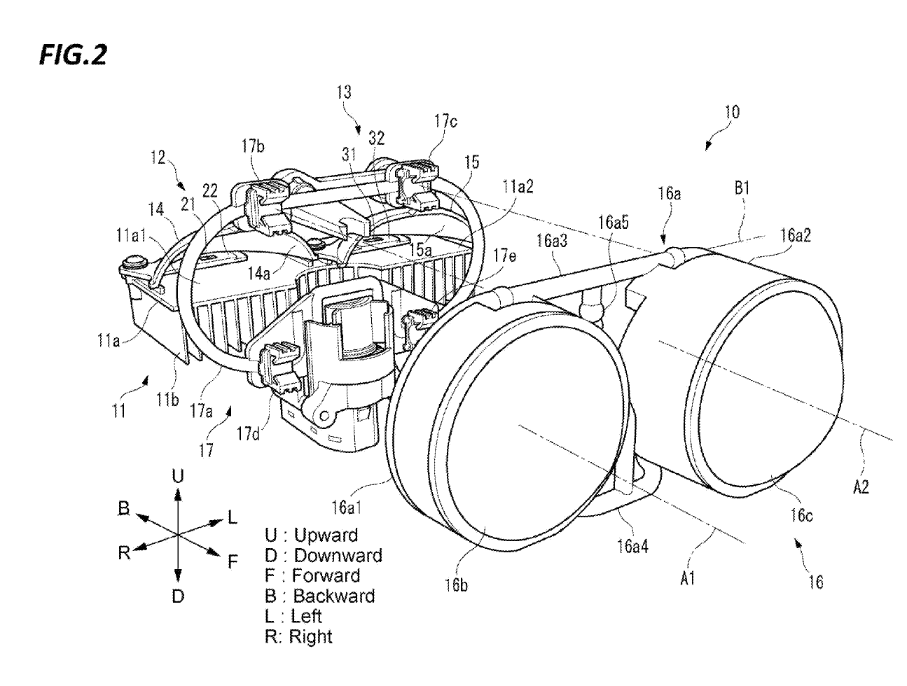

FIG. 2 is a perspective view illustrating the lamp unit 10 which is viewed from a front and upper side in a state in which the projection lens unit 16 is separated from the joint unit 17.

The heat sink 11 is provided with a light source support plate 11a and a plurality of heat radiation plates 11b. The light source support plate 11a extends in left and right directions of the lamp unit 10. The light source support plate 11a includes a first support portion 11a1 disposed at a right side of the central portion in the left and right directions of the lamp unit 10. The light source support plate 11a includes a second support portion 11a2 disposed at left side of the central portion in the left and right directions of the lamp unit 10. The plurality of heat radiation plates 11b extends downward from the light source support plate 11a.

The first light source unit 12 is provided with a first light source 21 and a first attachment 22. The first light source 21 is, for example, a white light emitting diode (LED). The first attachment 22 fixes the first light source 21 on the first support portion 11a1. The first attachment 22 includes a connector (not illustrated). The first light source 21 is turned ON by an electric power supplied through the connector.

The second light source unit 13 is provided with a second light source 31 and a second attachment 32. The second light source 31 is, for example, a white light emitting diode (LED). The second attachment 32 fixes the second light source 31 on the second support portion 11a2. The second attachment 32 includes a connector (not illustrated). The second light source 31 is turned ON by an electric power supplied through the connector.

The first reflector 14 is dome-shaped. An inner surface 14a of the first reflector 14 is formed in a reflective surface. The first reflector 14 is disposed such that a portion of the reflective surface faces the first light source 21.

The second reflector 15 is dome-shaped. The inner surface 15a of the second reflector 15 is formed in a reflective surface. The second reflector 15 is disposed such that a portion of the reflective surface faces the second light source 31.

The projection lens unit 16 is provided with a lens holder 16a, a first projection lens 16b, and a second projection lens 16c. The lens holder 16a includes a first lens holding frame 16a1, a second lens holding frame 16a2, an upper connecting shaft 16a3, a lower connecting shaft 16a4, and an intermediate connecting shaft 16a5.

The first projection lens 16b (an example of a first lens unit) has a first optical axis A1. The first projection lens 16b is fixed on a front surface of the first lens holding frame 16a1. The second projection lens 16c (an example of a second lens unit) has a second optical axis A2. The second projection lens 16c is fixed on a front surface of the second lens holding frame 16a2.

The upper connecting shaft 16a3 (an example of a first shaft member) has an axis B1 (an example of a first axis) extending in the left and right directions (an example of the first direction) of the lamp unit 10 and is connected to an upper portion of the first lens holding frame 16a1 and the second lens holding frame 16a2. The lower connecting shaft 16a4 (an example of the first shaft member) has an axis B2 (the example of the first axis) extending in the left and right directions (an example of the first direction) of the lamp unit 10 and connects a lower portion of the first lens holding frame 16a1 and a lower portion of the second lens holding frame 16a2.

The intermediate connecting shaft 16a5 extends in upward and downward directions (an example of a second direction) orthogonal to the left and right directions of the lamp unit 10 between the first lens holding frame 16a1 and the second lens holding frame 16a2 to connect the upper connecting shaft 16a3 and the lower connecting shaft 16a4.

The joint unit 17 is disposed between the heat sink 11 and the projection lens unit 16. The joint unit 17 is provided with an annular frame 17a, a right upper bearing 17b, a left upper bearing 17c, a right lower bearing 17d, and a left lower bearing 17e.

The right upper bearing 17b is disposed adjacent to an upper right side of the annular frame 17a and includes a pair of opened holding members at the front side. The left upper bearing 17c is disposed adjacent to an upper left side of the annular frame 17a and includes a pair of opened holding members at the front side. The projection lens unit 16 is joined with the joint unit 17. In such a case, the right end of the upper connecting shaft 16a3 of the lens holder 16a is held in the right upper bearing 17b (an example of the first bearing member) and the left end of the upper connecting shaft 16a3 is held in the left upper bearing 17c (an example of the first bearing member). The left end and the right end of the upper connecting shaft 16a3 are maintained to be slidable in the directions where the upper connecting shaft 16a3 extends (i.e., in the left and right directions of the lamp unit 10) in the right upper bearing 17b and the left upper bearing 17c, respectively.

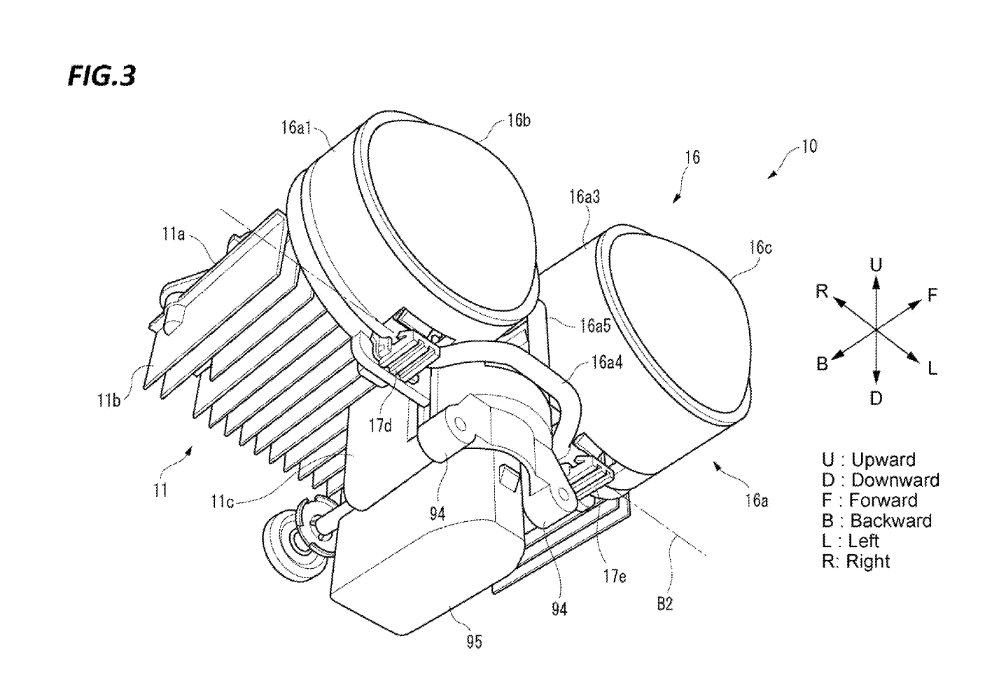

FIG. 3 is a perspective view of the lamp unit 10 which is viewed from a lower front side. When the projection lens unit 16 is joined with the joint unit 17, the right end of the lower connecting shaft 16a4 of the lens holder 16a is held in the right lower bearing 17d (an example of the first bearing member) and the left end of the lower connecting shaft 16a4 is held in the lower-left bearing 17e (an example of the first bearing member). The left end and the right end of the lower connecting shaft 16a3 are maintained to be slidable in the direction where the lower connecting shaft 16a4 extends (i.e., in the left and right directions of the lamp unit 10) in the right lower bearing 17b and the left lower bearing 17c, respectively.

In this state, the first projection lens 16b is disposed such that at least some of the light emitted from the first light source 21 passes therethrough. The second projection lens 16c is disposed such that at least some of the light emitted from the second light source 31 passes therethrough.

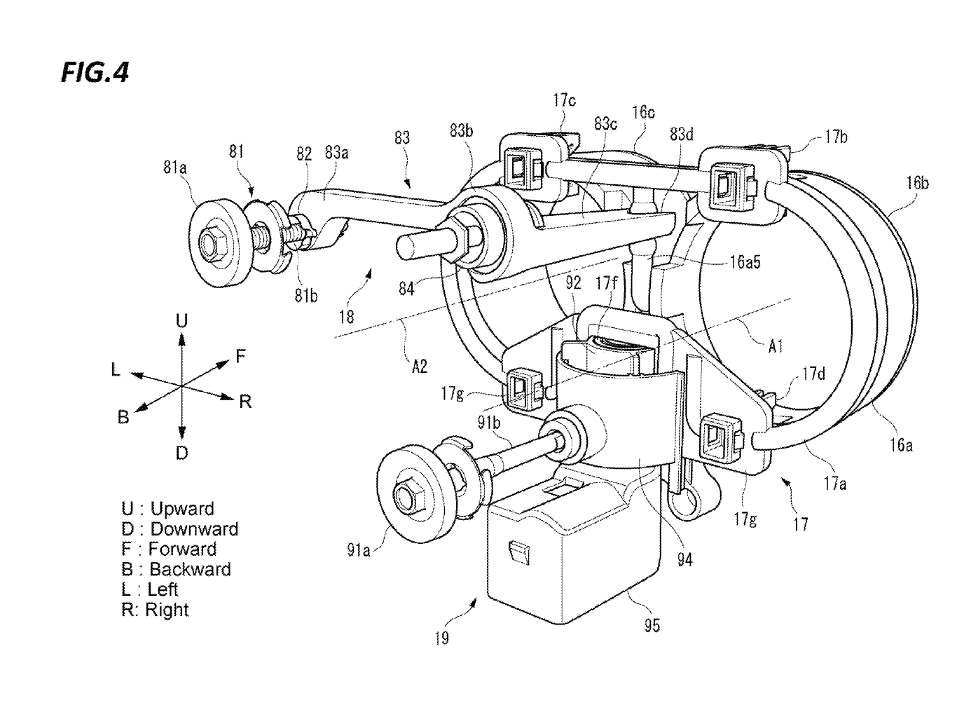

FIG. 4 is a perspective view of a portion of the lamp unit 10 (in a state where the heat sink 11, the first light source unit 12, the second light source unit 13, the first reflector 14, and the second reflector 15 are removed) which is viewed from upper-rear side. The lamp unit 10 further includes a first adjusting mechanism 18.

The first adjusting mechanism 18 is provided with a first screw 81, a joint 82, a link 83, and a fulcrum member 84. The first adjusting mechanism 18 is configured to move the projection lens unit 16 in parallel in the left and right directions of the lamp unit 10 with respect to the first light source 21 and the second light source 31.

The first screw 81 includes a head portion 81a and a shank portion 81b. As illustrated in FIG. 1, the shaft member 81b extends through a back wall 2a of the housing 2. The head member 81a is disposed outside the back wall 2a to be rotated using a jig. Threads are formed on the outer circumferential surface of the shank portion 81b.

As illustrated in FIG. 4, the joint 82 includes a pair of holding members in which threads are formed on facing surfaces of the holding members. The pair of holding members maintains the shank portion 81b of the first screw 81 such that the threads of the holding members and the thread of the shaft member 81b are screw-engaged with each other.

A first end 83a of the link 83 is joined with the joint 82. A second end 83b of the link 83 is connected to the fulcrum member 84. A rear end of the fulcrum member 84 is fixed to the back wall 2a of the housing 2.

As illustrated in FIG. 4, the link 83 has an arm portion 83c extending forward at a spot adjacent to the second end 83b. A fitting groove 83d is formed at the front end of the arm portion 83c. The intermediate connecting shaft 16a5 of the lens holder 16a is held in the fitting groove 83d. The intermediate connecting shaft 16a5 is adapted to be slidable in the direction where the intermediate connecting shaft extends (i.e., in the upward and downward directions of the lamp unit 10) in the fitting groove 83d.

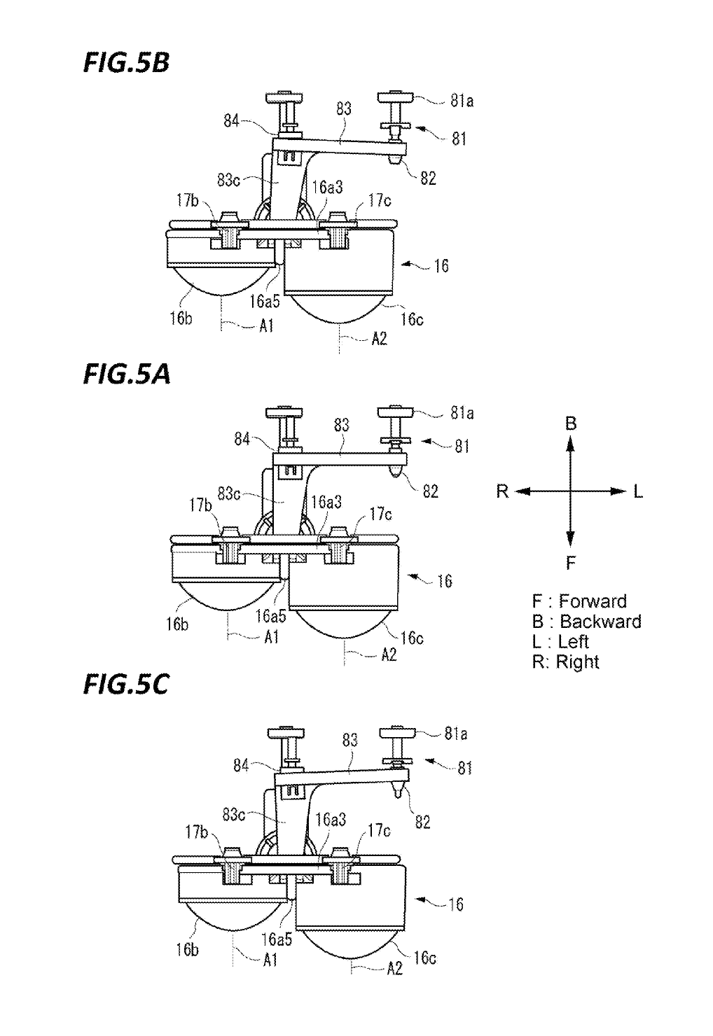

FIGS. 5A to 5C are plan views for explaining a movement of each portion of the lamp unit 10 according to the rotation of the first screw 81. The FIG. 5A illustrates an initial state.

In this state, when the first screw 81 is rotated to the left, the first end 83a of the link 83 will be pushed forward through the joint 82. Accordingly, through the arm portion 83c of the link 83 which pivots about the fulcrum member 84, the intermediate shaft 16a5 of the lens holder 16a is pushed to the right. At this time, the upper connecting shaft 16a3 and the lower connecting shaft 16a4 are slid to the right in the right upper bearing 17b, the left upper bearing 17c, the right lower bearing 17d, and the left lower bearing 17e of the joint 17. Therefore, as illustrated in FIG. 5B, the projection lens unit 16 is moved to the right in parallel. As a result, the first optical axis A1 of the first projection lens 16b and the second optical axis A2 of the second projection lens 16c are moved to the right in parallel in unison.

Meanwhile, when the first screw 81 is rotated to the right, the first end 83a of the link 83 will be pulled backward through the joint 82. Accordingly, through the forearm unit 83c of the link 83 which pivots about the fulcrum member 84, the intermediate shaft 16a5 of the lens holder 16a is pushed to the left. At this time, the upper connecting shaft 16a3 and the lower connecting shaft 16a4 are slid to the right upper bearing 17b, the left upper bearing 17c, the right lower bearing 17d, and the left lower bearing 17e of the joint 17. Therefore, as illustrated in FIG. 5C, the projection lens unit 16 is moved to the left in parallel. As a result, the first optical axis A1 of the first projection lens 16b and the second optical axis A2 of the second projection lens 16c are moved to the left in parallel in unison.

That is, when the head member 81a of the first screw 81 is operated, the reference positions of the first optical axis A1 of the first projection lens 16b and the second optical axis A2 of the second projection lens 16b are adjusted in the left and right directions of the lamp unit 10. The upper connecting shaft 16a3 and the lower connecting shaft 16a4 of the lens holder 16a, and the right upper bearing 17b, the left upper bearing 17c, the right lower bearing 17d and the left lower bearing 17e of the joint unit 17 also constitute a portion of the first adjusting mechanism 18.

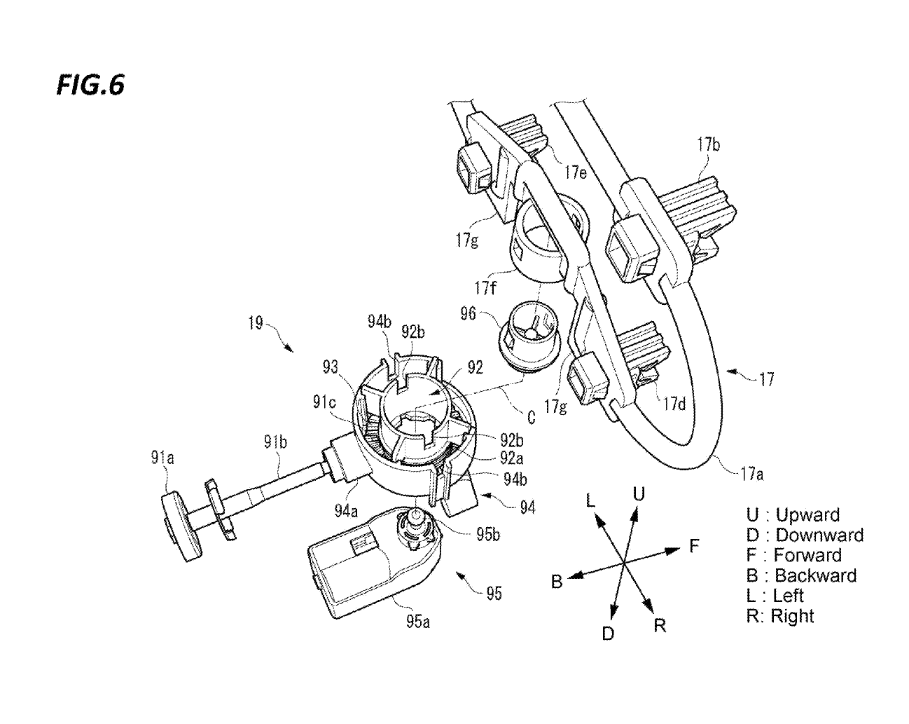

As illustrated in FIG. 4, the lamp unit 10 further includes a second adjusting mechanism 19. FIG. 6 is an exploded perspective view illustrating the configuration of the second adjusting mechanism 19. The second adjusting mechanism 19 is configured to move the projection lens unit 16 in parallel in the upward and downward directions of the lamp unit 10 with respect to the first light source 21 and the second light source 31. The second adjusting mechanism 19 is provided with a second screw 91, a slider 92, an annular gear 93, and a support frame 94.

The second screw 91 includes a head portion 91a, a shank portion 91b, and a gear 91c. As illustrated in FIG. 1, the shank portion 91b extends through the back wall 2a of the housing 2. The head portion 91a is disposed outside the back wall 2a to be rotated by using a jig. The gear 91c is mounted on the front end of the shank portion 91b.

The slider 92 is a hollow cylindrical frame. Threads 92a are formed on an outer circumferential surface of a lower portion of the slider 92. Meanwhile, threads (not illustrated) are formed on an inner circumferential surface of the annular gear 93. The annular gear 93 is joined with the slider 92 such that the threads thereof may be screw-engaged with the threads 92a.

The support frame 94 is a hollow cylindrical frame in which an opening 94a is formed at a portion of the side wall. After being coupled to each other, the slider 92 and the annular gear 93 are placed inside the support frame 94. The first screw 91 is inserted into and extends through the opening 94a, and the gear 91c and the annular gear 93 are engaged with each other. The annular gear 93 is supported by the support frame 94 to be rotatable about an axis C. The slider 92 is supported by the support frame 94 to be slidable along the axis C. The axis C extends in the upward and downward directions. That is, in this state, the slider 92 (an example of the second shaft member) has the axis C extending in the upward and downward directions of the lamp unit 10, and is held in the support frame 94 (an example of the second bearing member).

A pair of slits 92b is formed in an upper end of the slider 92. A pair of slits 94b is formed in an upper end of the support frame 94 to face the pair of slits 92b. Meanwhile, a coupling shaft 17f and a pair of coupling members 17g are formed in a lower portion of the annular frame 17a of the joint unit 17. The coupling shaft 17f is disposed between the pair of coupling members 17g to extend downward. An outer diameter of the cylindrical coupling shaft 17f and an inner diameter of the slider 92 are substantially equal to each other. The joint unit 17 is coupled to the slider 92 and the support frame 94 when the coupling shaft 17f is fitted in the slider 92 and the pair of coupling members 17g are fitted in the pair of slits 92b and 94b.

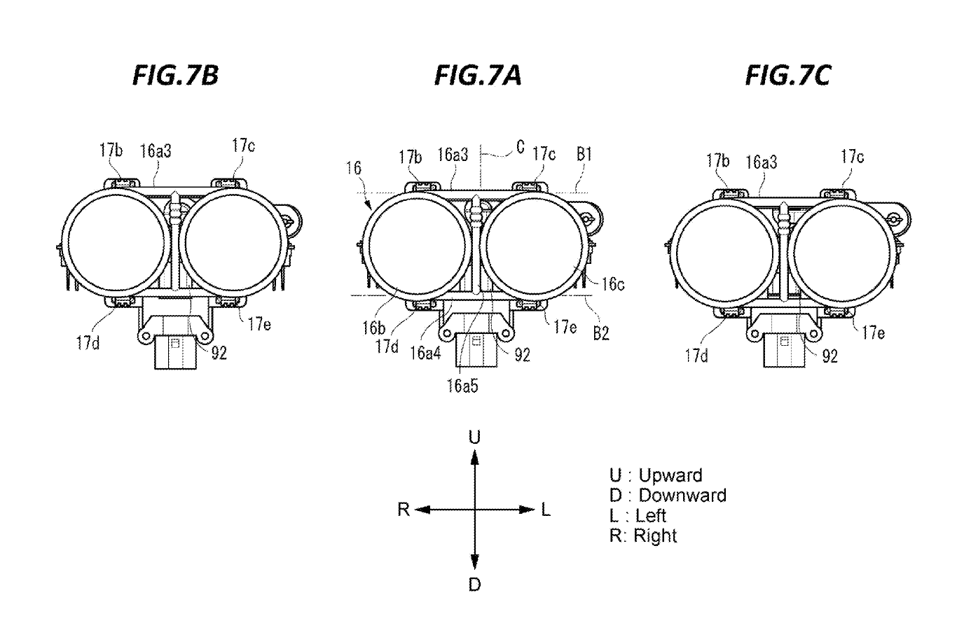

FIGS. 7A to 7C are front views for describing a movement of each portion of the lamp unit 10 according to the rotation of the second screw 91. FIG. 7A illustrates an initial state.

In this state, when the second screw 91 is rotated to the right, the annular gear 93 is rotated to the right about the axis C through the gear 92c. According to the rotation, the slider 92 having threads 92a screw-engaged with the screw threads of the annular gear 93 are slid upward along the axis C. When the slider 92 is slid upward, the annular frame 17a coupled to the slider 92 through the coupling shaft 17f is displaced upward (see, e.g., FIG. 4).

Therefore, as illustrated in FIG. 7B, the projection lens unit 16, which is supported by the right upper bearing 17b, the left upper bearing 17c, the right lower bearing 17d, and the left lower bearing 17e which are provided on the annular frame 17a, move upward in parallel. At this time, the intermediate connecting shaft 16e of the lens holder 16a is slid upward in the fitting groove 83d of the link 83 (see, e.g., FIG. 4). As a result, the first optical axis A1 of the first projection lens 16b and the second optical axis A2 of the second projection lens 16c are moved upward in parallel in unison.

Meanwhile, when the second screw 91 is rotated to the left, the annular gear 93 is rotated to the left about the axis C through the gear 92c. According to the rotation, the slider 92 including the threads 92a screw-coupled with the threads of the annular gear 93 is slid downward along the axis C. When the slider 92 is slid downward, the annular frame 17a coupled to the slider 92 through the coupling shaft 17f is displaced downward (see, e.g., FIG. 4).

Therefore, as illustrated in FIG. 7C, the projection lens unit 16, which is maintained by the right upper bearing 17b, the left upper bearing 17c, the right lower bearing 17d, and the left lower bearing 17e which are provided on the annular frame 17a, is moved downward in parallel. At this time, the intermediate connecting shaft 16e of the lens holder 16a is slid downward in the fitting groove 83d of the link 83 (see, e.g., FIG. 4). As a result, the first optical axis A1 of the first projection lens 16b and the second optical axis A2 of the second projection lens 16c are moved downward in parallel in unison.

That is, when the head portion 91a of the second screw 91 is operated, the reference position of the first optical axis A1 of the first projection lens 16b and the second optical axis A2 of the second projection lens 16b are adjusted in the upward and downward directions of the lamp unit 10. The right upper bearing 17b, the left upper bearing 17c, the right lower bearing 17d and the left lower bearing 17e of the joint unit 17 constitute a portion of the second adjusting mechanism 19.

As illustrated in FIG. 4, the first optical axis A1 of the first projection lens 16b and the second optical axis A2 of the second optical axis A2 extend in the forward and backward directions of the lamp unit 10 (an example of the third direction). That is, the direction in which the first optical axis A1 and the second optical axis A2 extend, is orthogonal to the direction in which the projection lens 16 is moved in parallel by the first adjusting mechanism 18 (the left and right directions of the lamp unit 10) and the direction in which the projection lens 16 is moved in parallel by the second adjusting mechanism (the upward and downward directions of the lamp unit 10).

According to the configuration described above, when the reference positions of the plurality of optical axes provided in the projection lens unit 16 are adjusted in unison, the projection lens unit 16 does not involve a displacement in the forward and backward directions of the lamp unit 10 (the direction in which the optical axis A1 and the optical axis A2 extend). Since it is not necessary to secure a space for allowing the displacement in the forward and backward directions of the lamp unit 10, an occupation space in the lamp chamber 3 of the headlight device 1 where the lamp unit 10 is disposed may be suppressed, and the space in the lamp chamber 3 may be effectively utilized. In a case where the projection lens unit which has plurality of optical axes and tends to be enlarged in structure is displaced, the above-mentioned effect becomes more remarkable.

In addition, since the projection lens unit 16 is moved in parallel, a relative position between a focal plane of the first projection lens 16b and the first light source 21 and a relative position between a focal plane of the second projection lens 16c and the second light source 31 are not changed when the reference positions of the first optical axis A1 and the second optical axis A2 are adjusted. Therefore, imaging of the light emitted from the first light source 21 and the light from the second light source 31 (i.e., formation of a light distribution pattern) may be stabilized.

As illustrated in FIG. 7A, the axis B1 of the upper connecting shaft 16a3 and the axis B2 of the lower connecting shaft 16a4 of the lens holder 16a are orthogonal to the axis C of the slider 92 between the first projection lens 16b and the second projection lens 16c, when viewed in the forward and backward directions of the lamp unit 10.

According to such a configuration, a displacement axis in the left and right directions and a displacement axis in the upward and downward directions may intersect each other at a position adjacent to a center of gravity of the projection lens unit 16. Therefore, the projection lens unit 16 which has a plurality of optical axes and tends to be increased in size and weight may be stably displaced.

As illustrated in FIG. 6, the second adjusting mechanism further includes an actuator 95. The actuator 95 is provided with a case 95a and a driving shaft 95b. The actuator 95 is coupled to the support frame 94 (see, e.g., FIG. 4). In this state, as illustrated in FIG. 6, the driving shaft 95b of the actuator 95 is disposed in the slider 92 and coupled to a connecting member 96. The connecting member 96 is fixed to a lower end of the coupling shaft 17f of the joint unit 17. Accordingly, the driving shaft 95b and the combining shaft 17f are not relatively displaced. That is, the driving shaft 95b is coupled to the slider 92 are through the coupling shaft 17f.

As illustrated in FIG. 3, a device support member 11c is provided under the supporting substrate 11a of the heat sink 11. The support frame 94 equipped with the actuator 95 is fixed to the device support member 11c by a fastening member (not illustrated).

The driving circuit provided in the case 95a of the actuator 95 receives a control signal from a control unit (not illustrated) disposed outside the lamp unit 10. The driving shaft 95b is configured to be movable forward and backward along the axis C with respect to the case 95a according to the control signal. As the driving shaft 95b moves forward and backward, the coupling shaft 17f of the joint unit 17 connected to the driving shaft 95b is slid in the slider 92 along the axis C.

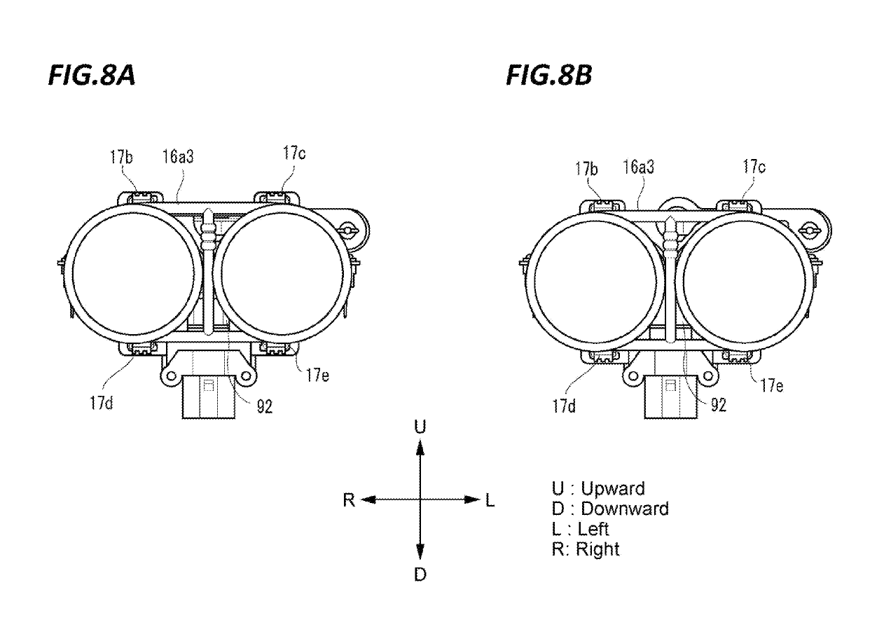

FIG. 8A illustrates a status in which the projection lens unit 16 is moved slightly downward when the second screw 91 is operated (which is the same as the state illustrated in FIG. 7C). FIG. 8B illustrates a state in which the driving shaft 95b is introduced into the case 95a and the projection lens unit 16 is further moved downward from the state when the second screw 91 is operated in the state illustrated in FIG. 8A.

That is, when the driving shaft 95b of the actuator 95 is further moved forward and backward with reference to the position of the projection lens unit 16 adjusted by operating the first screw 81 and the second screw 92, the reference positions of the first axis A1 and the second axis A2 may be displaced in the upward and downward directions of the lamp unit 10 in unison.

According to such a configuration, a control may be executed to move the reference positions of the first optical axis A1 and the second optical axis A2 in the upward and downward direction of the vehicle according to a change in height of the vehicle which is caused depending on the number of passengers or load on the vehicle may be performed. That is, the mechanism which displaces the projection lens unit 16 in the upward and downward directions of the lamp unit 10 may also be used for a so-called leveling control.

The above-described exemplary embodiments are provided in order to help the easy understanding of the present disclosure, and are not intended to limit the present disclosure. It is obvious that the present disclosure may be modified or improved without departing from the scope thereof and the present disclosure includes equivalents thereof.

In the above-described exemplary embodiment, the first projection lens 16b and the second projection lens 16c in the projection lens unit 16 are configured as independent projection lenses. According to such a configuration, standardization of lens components may be facilitated, and a component cost and a manufacturing cost may be suppressed.

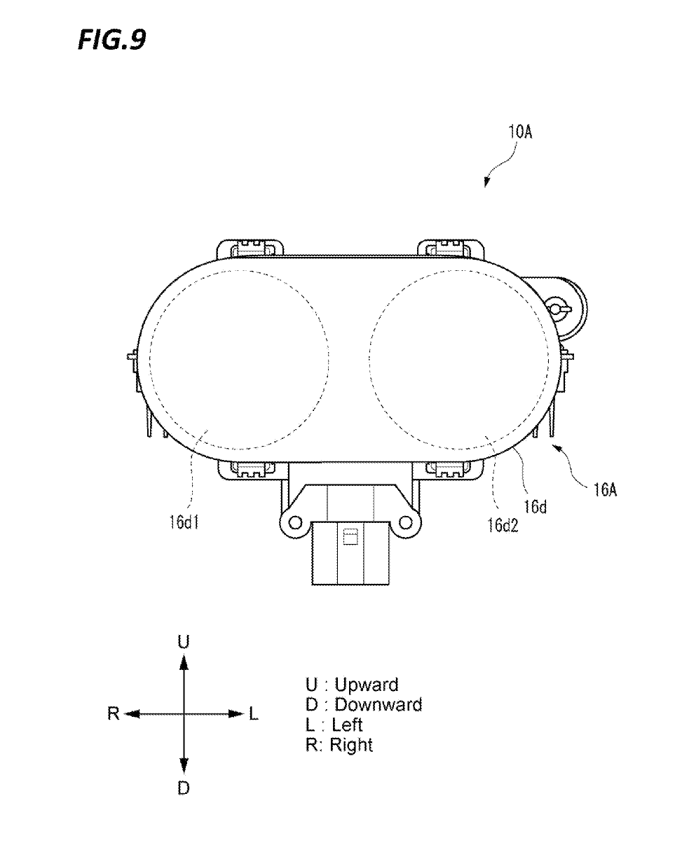

Meanwhile, like a lamp unit 10A in a modified embodiment illustrated in FIG. 9, a projection lens 16A may be configured to include a single projection lens 16d. In such a case, at least some of the light emitted from a light source 21 passes through a first area 16d1 (an example of the first lens unit) of the projection lens 16d and at least some of the light emitted from the light source 31 passes through a second area 16d2 (an example of the second lens unit) of the projection lens 16d.

In the above-described exemplary embodiment, the first optical axis A1 of the first projection lens 16b and the second optical axis A2 of the first projection lens 16b extend in parallel to each other in the forward and backward directions of the lamp unit 10. However, as long as one of the first optical axis A1 and the second optical axis A2 extends in the above-described directions, the other may extend to be inclined in relation to the above-described directions.

A lighting device equipped with the lamp unit 10 is not limited to the headlight device 1. The lamp unit 10 may be equipped in a proper vehicular illumination device as long as the adjustment of the reference positions of the first optical axis A1 and the second optical axis A2 of the projection lens unit 16 is utilized in a needed use.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lamp unit equipped in a vehicle, the lamp unit comprising;
a first light source;
a second light source;
a projection lens unit including a first lens unit, through which at least some of light emitted from the first light source passes, and a second lens unit, through which at least some of light emitted from the second light source passes;
a first adjusting mechanism configured to move the projection lens unit in parallel in a first direction with respect to the first light source and the second light source; and
a second adjusting mechanism configured to move the projection lens unit in parallel in a second direction with respect to the first light source and the second light source, the second direction being orthogonal to the first direction,
wherein at least one of the first optical axis of the first lens and the second optical axis of the second lens extends in a third direction which is orthogonal to the first direction and the second direction.

2. The lamp unit of claim 1, wherein the first adjusting mechanism includes a first shaft member having a first axis extending in the first direction, and a first bearing member configured to hold the first shaft member,
the second adjusting mechanism includes a second shaft member having a second axis extending in the second direction and a second bearing member configured to hold the second axis member, and
the first axis and the second axis intersect each other between the first lens unit and the second lens unit when viewed in the third direction.

3. The lamp unit of claim 2, further comprising an actuator which includes a driving shaft coupled to the second shaft member,
wherein the second direction corresponds to upward and downward directions of the vehicle.

4. The lamp unit of claim 1, wherein the first lens unit includes a first projection lens and the second lens unit includes a second projection lens which is independent from the first projection lens.

5. The lamp unit of claim 2, wherein the first lens unit includes a first projection lens and the second lens unit includes a second projection lens which is independent from the first projection lens.

6. The lamp unit of claim 3, wherein the first lens unit includes a first projection lens and the second lens unit includes a second projection lens which is independent from the first projection lens.
